(19) United States
(12) Patent Application Publication
(10) Pub. No.: US 2007/0186455 A1
(43) Pub. Date: Aug. 16, 2007

(54) System for attaching decorative identifiers to apparel and accessories

(76) Inventor: Stephanie Lin, Beverly Hills, CA (US)

Correspondence Address: CARLOS CANDELORO, 1601 N. SEPULVEDA BLVD., # 239, MANHATTAN BEACH, CA, 90266, US

(21) Appl. No.: 11/652,391

(22) Filed: Jan. 11, 2007

Related U.S. Application Data
(63) Continuation of application No. 10/836,696, filed on Apr. 30, 2004.

(51) Int. Cl. G09F 23/00

(52) U.S. Cl. 40/640

(57) ABSTRACT

A system for attaching decorative identifiers to apparel and accessories includes a backing band attached at at least an upper edge to the item. The band has vertical slits to accommodate a display belt interwoven through the slits to form hanging loops. Decorative identifiers such a letters, charms, or insignia are suspended from identifier hangers. The hangers are shaped to fit pivotally over the hanging loops. The display belt is attached to either the item or the backing band at one end and may be removably attached to the item or the backing band at the other end to allow for easy removal of the hangers. The display belt is attached to the item or backing band using a pair of rings, a buckle, a snap, Velcro® fasteners or buttons. The decorative identifiers may be attached to the hangers permanently or using split or openable rings, swivels or spring clips.

### RELATED APPLICATIONS

This application is a continuation of prior application Ser. No. 10/836,696, filed Apr. 30, 2004, which application is incorporated herein by reference in its entirety.

### FIELD OF INVENTION

The invention pertains to decorative identifiers such as letters, charms, etc. for apparel and accessories. More particularly, the invention relates to means for attaching such identifiers to items such as purses, hats, belts, shoes, backpacks and similar items.

### BACKGROUND OF THE INVENTION

Various devices have been developed for attaching ornamental identifiers to articles of clothing and related accessories. The best among such devices have been both utilitarian in their means of attachment and also ornamental in appearance. Common means of attaching the identifiers have included Velcro® fasteners, snaps, buckles, etc.

U.S. Pat. No. 4,907,633, issued to Eckstein, discloses a handbag assembly according to which a variety of outer decorative coverings can be selectively attached to the main article carrying bag to suit the desired decor. An outer decorative covering of a desired decor substantially envelops the main article carrying bag and is attached to the carrying bag at locations proximate to the upper rim. The handles may be reovable from the carrying bag and changed according to the desired decor and may be of different functional designs.

U.S. Pat. No. 4,982,580, issued to Otenbaker, describes a convertible article of jewelry that has a base member that is capable of securely holding a number of studded ornaments arranged in varying fashions by the user thereof. The article has an attachment element so that it may be worn on clothing or as a necklace pendant.

U.S. Pat. No. 5,283,966, issued to Rader, et al., illustrates a badge including a badge plate and multiple and interchangeable means of fastening the badge to clothing or other items that are releasably attached, allowing the means of fastening to be interchanged. The means of fastening the badge includes a clip, a pair of military style pins, an alligator clip, a horizontal pin or a magnet.

U.S. Pat. No. 5,697,387, issued to Hanisco, discloses a removable flexible material cover for an article of fashion such as, hair barrettes, jewelry, and belt buckles. The cover comprises one or more pieces of said flexible material, with at least one piece of material being a shape similar to the shape of the article to be covered. An elasticized band is sewn or otherwise held along the perimeter of the material piece or pieces. The elasticized band acts to pull the material taut over the fashion accessory base, and thus assists in holding the cover in place. Decorative embellishments may be attached to the cover if desired, for further aesthetic appeal so that different decorations, at the discretion of the wearer, may be removably employed.

U.S. Pat. No. 5,742,939, issued to Williams, describes a play costume comprised of a plurality of pads detachably mountable on body worn apparel. Optional items such as a belt and carrying bag with a draw string for transporting and storing the play costume parts may be packaged with the play costume as part of a costume kit. Further peripherals which may be included with the costume include: an integral sound system, interchangeable pads, simulated weapons, infrared detection systems, a powered simulated eye patch, interchangeable program cartridges and an integral light system.

U.S. Pat. No. 5,803,266, issued to Blackwelder, illustrates an accessories kit for allowing a user to coordinate a clothing accessory with a variety of outfits without the expense of purchasing a separate clothing accessory for each outfit. The accessories kit includes a clothing accessory and a plurality of decorative, interchangeable ornaments for attachment to the clothing accessory. At least one of the ornaments is secured to the exterior surface of the clothing accessory by a Velcro® fastener.

It is an objective of the invention to provide an easy to use and attractive means for attaching identifying ornamentation to articles of apparel and related accessories. It is a further objective to provide means for attaching such identifiers in a manner that allows for them to be easily removed, rearranged and reused. Finally, it is an objective of the invention to provide a system for attaching such identifiers that is durable and economical to manufacture.

While some of the objectives of the present invention are disclosed in the prior art, none of the inventions found include all of the requirements identified.

### SUMMARY OF THE INVENTION

The present invention addresses all of the deficiencies of prior art systems for attaching decorative identifiers to apparel and accessories and satisfies all of the objectives described above.

(1) A system for attaching decorative identifiers to apparel and accessories providing the desired features may be constructed from the following components. A backing band is provided. The backing band has a first end, a second end, an upper edge, a lower edge and is attached adjacent at least one of the upper and lower edges to an outer surface of an item of apparel or an accessory item. The backing band has at least two slits disposed substantially vertically between the upper edge and the lower edge. A display belt is provided. The display belt has a first end, a second end, an upper edge, a lower edge and is sized and shaped to fit slidably through the slits. The display belt is interwoven through the slits to provide at least two hanging loops in the display belt. The display belt is secured to the backing band, the item of apparel or the accessory item at at least one of the first end and the second end of the belt.

At least one decorative identifier is provided. The identifier has an suspension fixture at its upper end. At least one identifier hanger is provided. The hanger has an upper end, a lower end and is sized, shaped and configured to attach to the hanging loop at the upper end and the suspension fixture at the lower end.

(2) In a variant of the invention, the display belt is secured to the backing band, the item of apparel or the accessory item at the first end and the second end of the belt.

(3) In another variant, the first end of the display belt is removably attached to the backing band, the item of apparel or the accessory item.

(4) In still another variant, the first end of the display belt is removably attached to a pair of rings, the rings are attached to the item of apparel, the accessory item or an additional section of display belt material attached to the item of apparel or the accessory item.

(5) In a further variant, the first end of the display belt is removably attached to a buckle. The buckle is attached to the item of apparel, the accessory item or an additional section of display belt material attached to the item of apparel or the accessory item.

(6) In still a further variant, the first end of the display belt is attached to a first snap portion and a second, mating snap portion is attached to the item of apparel, the accessory item or an additional section of display belt material attached to the item of apparel or the accessory item.

(7) In another variant of the invention, the first end of the display belt has a button hole and a mating button is attached to the item of apparel, the accessory item or an additional section of display belt material attached to the item of apparel or the accessory item.

(8) In yet another variant, the first end of the display belt has a hooking portion or a looping portion and a mating hooking portion or a mating looping portion is attached to the item of apparel, the accessory item or an additional section of display belt material attached to the item of apparel or the accessory item.

(9) In still another variant, the upper end of the identifier hanger has an opening. The opening is sized, shaped and configured to permit the hanger to fit frictionally over the display belt, thereby allowing interchangeability of the decorative identifier without removal of at least one end of the display belt from the backing band, the item of apparel or the accessory item.

(10) In a further variant, the upper end of the identifier hanger is a closed loop.

(11) In still a further variant, the upper end of the identifier hanger has a rectangular opening. The rectangular opening is sized and shaped to fit pivotally upon the display belt.

(12) In yet a further variant, the upper end of the identifier hanger has a rounded opening. The rounded opening is sized and shaped to fit pivotally upon the display belt.

(13) In another variant of the invention, the display belt has at least one snap portion attached at the hanging loop and the identifier hanger has a mating snap portion attached at the upper end of the hanger.

(14) In still another variant, the display belt has at least one aperture. The aperture penetrates the hanging loop and the upper end of the identifier hanger is sized and shaped to engage the aperture.

(15) In yet another variant, the display belt has at least one aperture. The aperture penetrating the hanging loop and the upper end of the identifier hanger is sized and shaped to removably engage the aperture.

(16) In a further variant, the lower end of the identifier hanger has an openable loop. The openable loop permits removal and replacement of the decorative identifier.

(17) In still a further variant, the openable loop has a split ring.

(18) In yet a further variant, the openable loop has a spring-loaded movable portion.

(19) In still another variant, the openable loop has a coil spring clip.

(20) In a final variant of the invention, the openable loop has a snap swivel.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a front elevational view of the preferred embodiment of the invention illustrating a purse having a backing band interwoven with a display belt supporting decorative identifiers hanging from identifier hangers;

FIG. 2 is a front elevational view of a second embodiment in which both ends of the display belt are attached to the backing band;

FIG. 3 is a front elevational view of the FIG. 1 embodiment, illustrating the first end of the display belt removed from the backing band;

FIG. 4 is a front elevational view of the FIG. 1 embodiment illustrating a buckle attachment for the display band;

FIG. 5 is a front elevational view of the FIG. 1 embodiment illustrating a snap attachment for the display band;

FIG. 6 is a front elevational view of an alternative version of the FIG. 2 embodiment in which both ends of the display belt are attached to the backing band;

FIG. 7 is a front elevational view of the FIG. 1 embodiment illustrating a button attachment for the display band;

FIG. 8 is a front elevational view of the FIG. 1 embodiment illustrating a hooking portion and looping portion attachment for the display band;

FIG. 9 is a perspective detailed view of a decorative identifier suspended from an identifier hanger attached to the display belt where the upper portion of the hanger is a closed loop;

FIG. 10 is a perspective detailed view of a decorative identifier suspended from an identifier hanger attached to the display belt where the upper portion of the hanger is shaped to slip over the display belt;

FIG. 11 is a perspective detailed view of a decorative identifier suspended from an identifier hanger attached to the display belt where the upper portion of the hanger has a rectangular opening;

FIG. 12 is a perspective detailed view of a decorative identifier suspended from an identifier hanger attached to the display belt where the upper portion of the hanger has a rounded opening;

FIG. 13 is a perspective detailed view of a decorative identifier suspended from an identifier hanger attached to the display belt where the upper portion of the hanger is attached to the display belt with a snap;

FIG. 14 is a perspective detailed view of a decorative identifier suspended from an identifier hanger attached to the display belt where the upper portion of the hanger is attached to an aperture in the display belt;

FIG. 15 is a perspective detailed view of a decorative identifier suspended from an identifier hanger attached to the display belt where the upper portion of the hanger is removably attached to an aperture in the display belt;

FIG. 16 is a perspective detailed view of a decorative identifier suspended from an identifier hanger attached to the display belt where the lower portion of the hanger has a split loop for attachment to the suspension fixture of the decorative identifier;

FIG. 17 is a perspective detailed view of a decorative identifier suspended from an identifier hanger attached to the display belt where the lower portion of the hanger has a spring-loaded openable loop for attachment to the suspension fixture of the decorative identifier;

FIG. 18 is a perspective detailed view of a decorative identifier suspended from an identifier hanger attached to the display belt where the lower portion of the hanger has a coil spring clip for attachment to the suspension fixture of the decorative identifier;

FIG. 19 is a perspective detailed view of a decorative identifier suspended from an identifier hanger attached to the display belt where the lower portion of the hanger has a swivel for attachment to the suspension fixture of the decorative identifier;

FIG. 20 is a perspective view of the backing band and display belt of the FIG. 1 embodiment attached to a hat;

FIG. 21 is a perspective view of the backing band and display belt of the FIG. 1 embodiment attached to a shoe;

FIG. 22 is a perspective view of the backing band and display belt of the FIG. 1 embodiment attached to a jacket; and

FIG. 23 is a perspective view of the backing band and display belt of the FIG. 1 embodiment attached to a belt.

### DETAILED DESCRIPTION OF THE PREFERRED EMBODIMENT

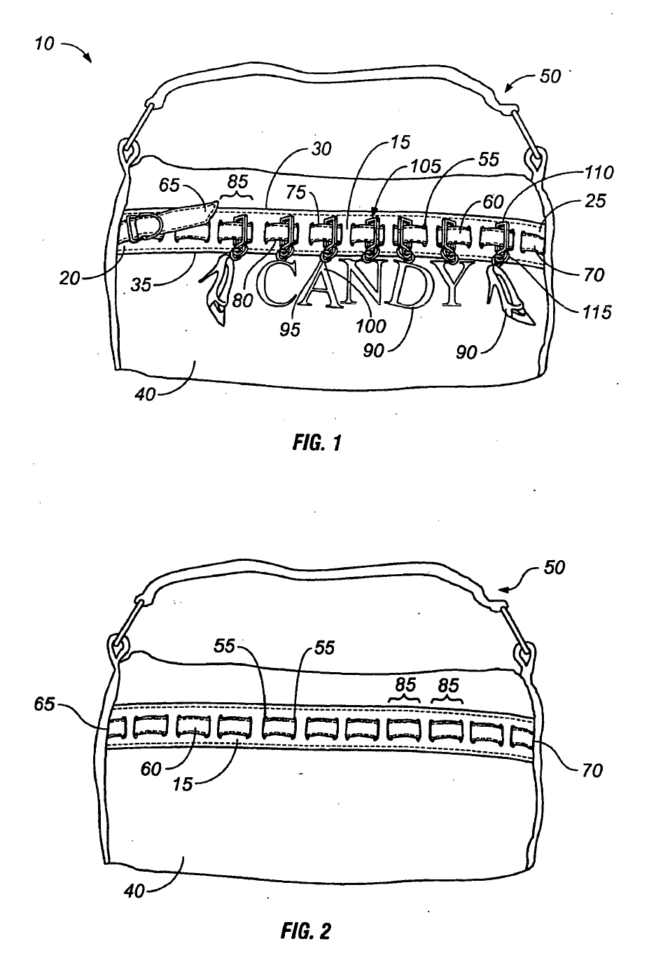

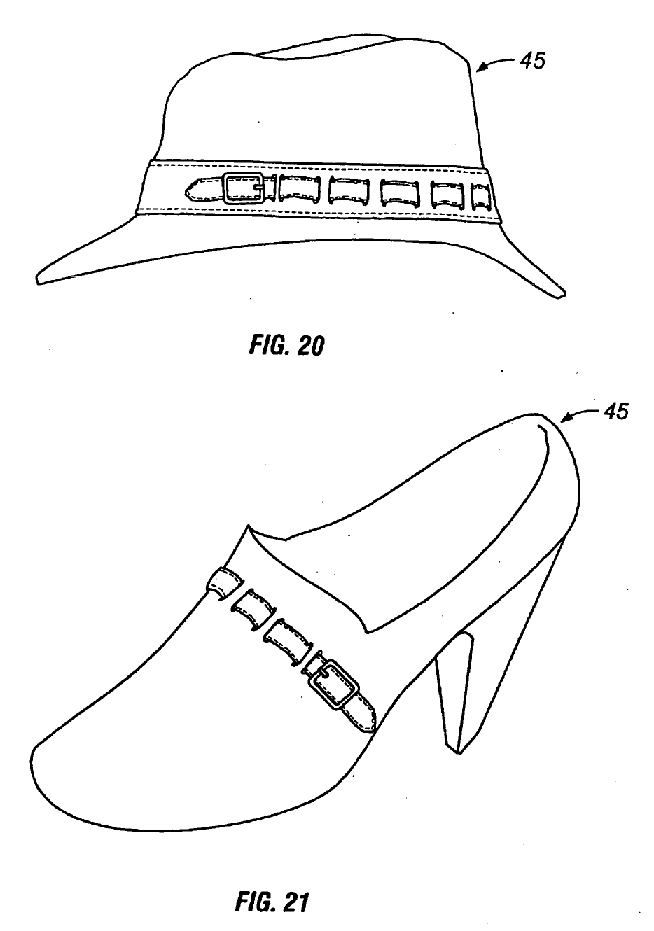

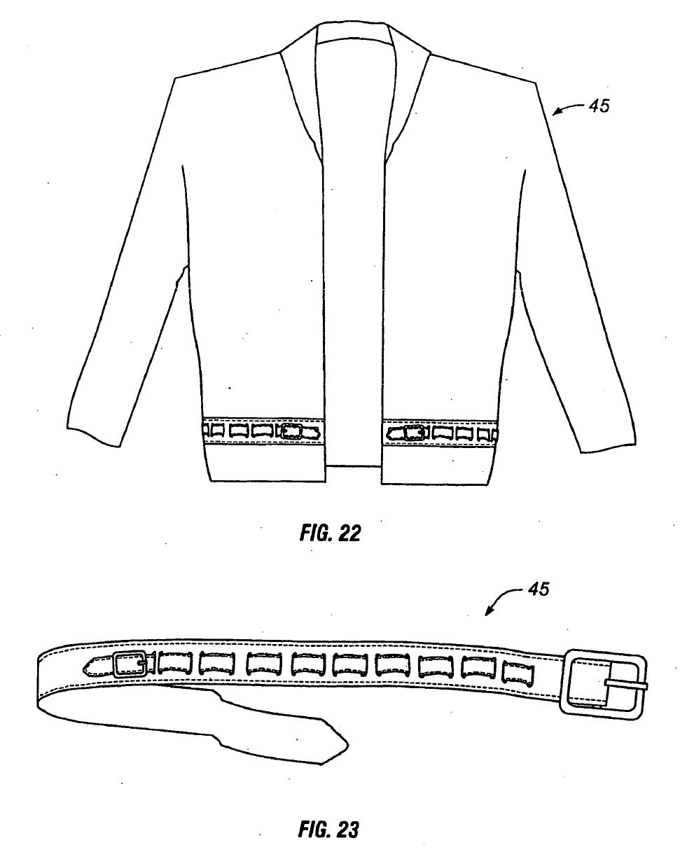

(1) FIGS. 1-23 illustrate a system for attaching decorative identifiers to apparel and accessories 10 providing the desired features that may be constructed from the following components. As illustrated in FIG. 1, a backing band 15 is provided. The backing band 15 has a first end 20, a second end 25, an upper edge 30, a lower edge 35 and is attached adjacent at least one of the upper 30 and lower 35 edges to an outer surface 40 of an item of apparel 45 or an accessory item 50. The backing band 15 has at least two slits 55 disposed substantially vertically between the upper edge 30 and the lower edge 35. A display belt 60 is provided. The display belt 60 has a first end 65, a second end 70, an upper edge 75, a lower edge 80 and is sized and shaped to fit slidably through the slits 55. The display belt 60 is interwoven through the slits 55 to provide at least two hanging loops 85 in the display belt 60. The display belt 60 is secured to the backing band 15, the item of apparel 45 or the accessory item 50 at at least one of the first end 65 and the second end 70 of the belt 60, as illustrated in FIGS. 1-8 and 20-23.

At least one decorative identifier 90 is provided. The identifier 90 has a suspension fixture 95 at its upper end 100. At least one identifier hanger 105 is provided. The hanger 105 has an upper end 110, a lower end 115 and is sized, shaped and configured to attach to the hanging loop 85 at the upper end 110 and the suspension fixture 95 at the lower end 115.

(2) In a variant of the invention, as illustrated in FIGS. 2 and 6, the display belt 60 is secured to the backing band 15, the item of apparel 45 or the accessory item 50 at the first end 65 and the second end 70 of the belt 60.

(3) In another variant, as illustrated in FIGS. 1, 3-5, 7 and 8, the first end 65 of the display belt 60 is removably attached to the backing band 15, the item of apparel 45 or the accessory item 50.

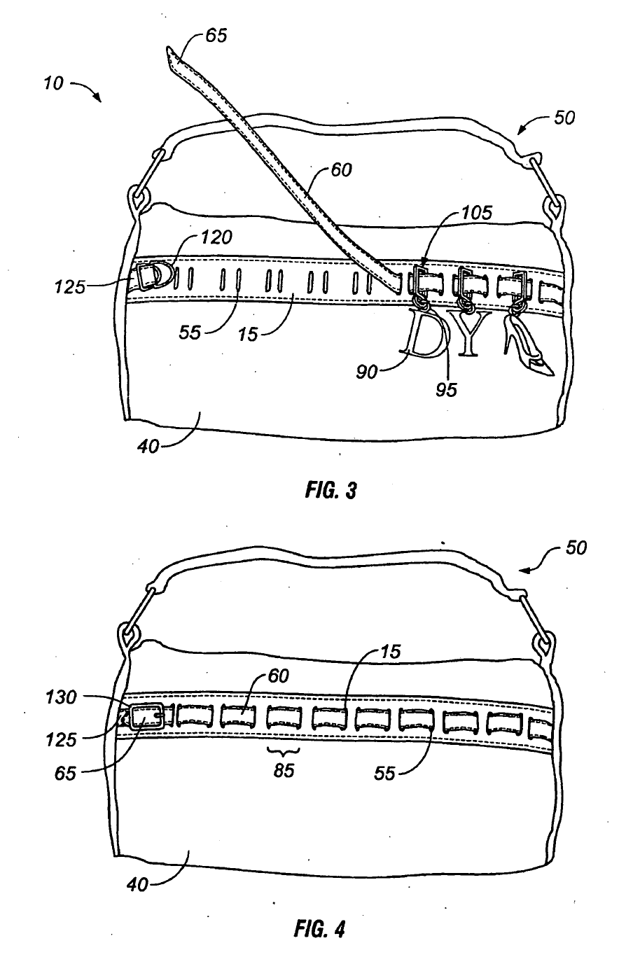

(4) In still another variant, as illustrated in FIGS. 1 and 3, the first end 65 of the display belt 60 is removably attached to a pair of rings 120, the rings 120 are attached to the item of apparel 45, the accessory item 50 or an additional section of display belt material 125 attached to the item of apparel 45 or the accessory item 50.

(5) In a further variant, as illustrated in FIG. 4, the first end 65 of the display belt 60 is removably attached to a buckle 130. The buckle 130 is attached to the item of apparel 45, the accessory item 50 or an additional section of display belt material 125 attached to the item of apparel 45 or the accessory item 50.

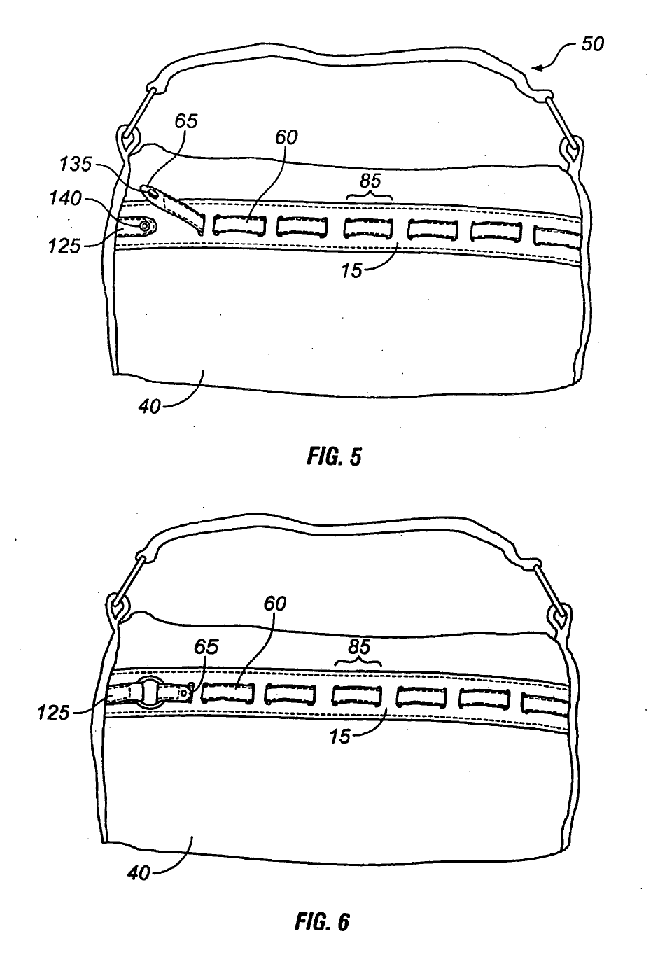

(6) In still a further variant, as illustrated in FIG. 5, the first end 65 of the display belt 60 is attached to a first snap portion 135 and a second, mating snap portion 140 is attached to the item of apparel 45, the accessory item 50 or an additional section of display belt material 125 attached to the item of apparel 45 or the accessory item 50.

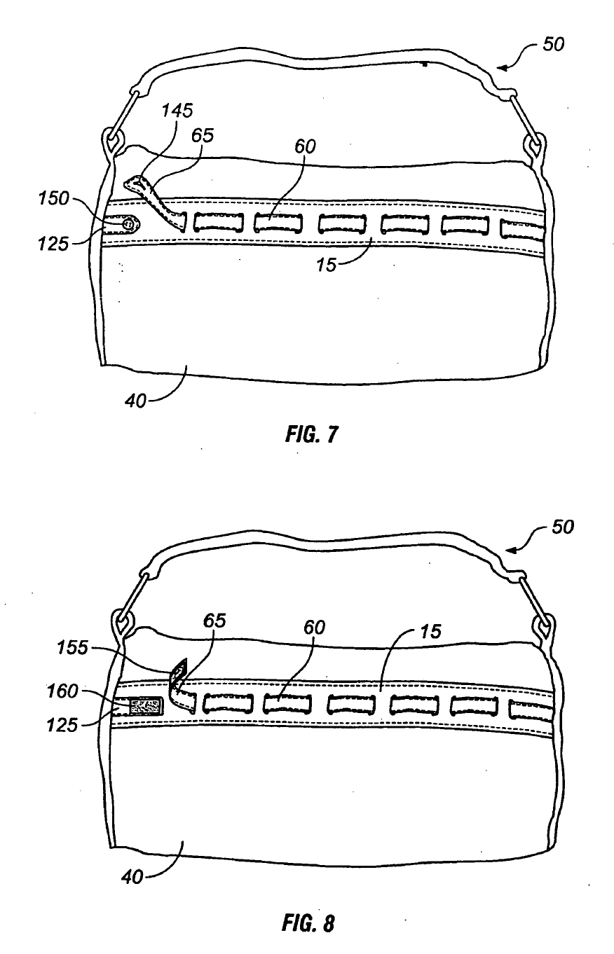

(7) In another variant of the invention, as illustrated in FIG. 7, the first end 65 of the display belt 60 has a button hole 145 and a mating button 150 is attached to the item of apparel 45, the accessory item 50 or an additional section of display belt material 125 attached to the item of apparel 45 or the accessory item 50.

(8) In yet another variant, as illustrated in FIG. 8, the first end 65 of the display belt 60 has a hooking portion 155 or a looping portion 160 and a mating hooking portion 155 or a mating looping portion 160 is attached to the item of apparel 45, the accessory item 50 or an additional section of display belt material 125 attached to the item of apparel 45 or the accessory item 50.

(9) In still another variant, as illustrated in FIG. 10, the upper end 110 of the identifier hanger 105 has an opening 155. The opening 155 is sized, shaped and configured to permit the hanger 105 to fit frictionally over the display belt 60, thereby allowing interchangeability of the decorative identifier 90 without removal of at least one end 65, 70 of the display belt 60 from the backing band 15, the item of apparel 45 or the accessory item 50.

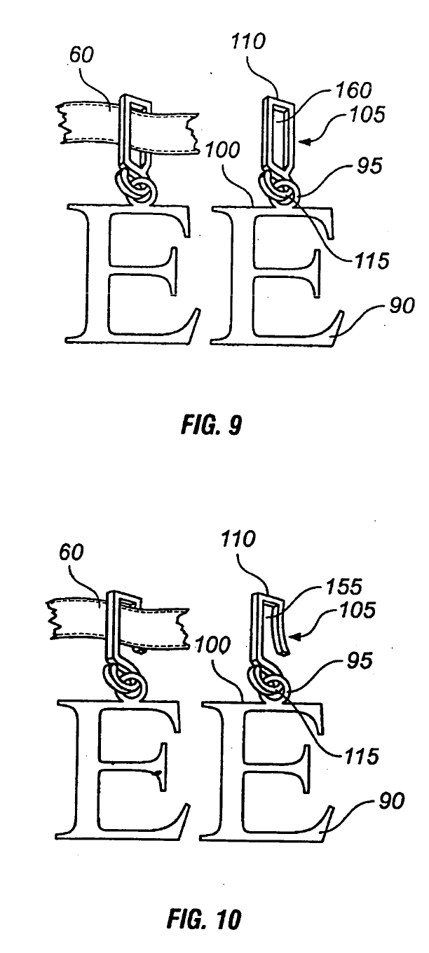

(10) In a further variant, as illustrated in FIG. 9, the upper end 110 of the identifier hanger 105 is a closed loop 160.

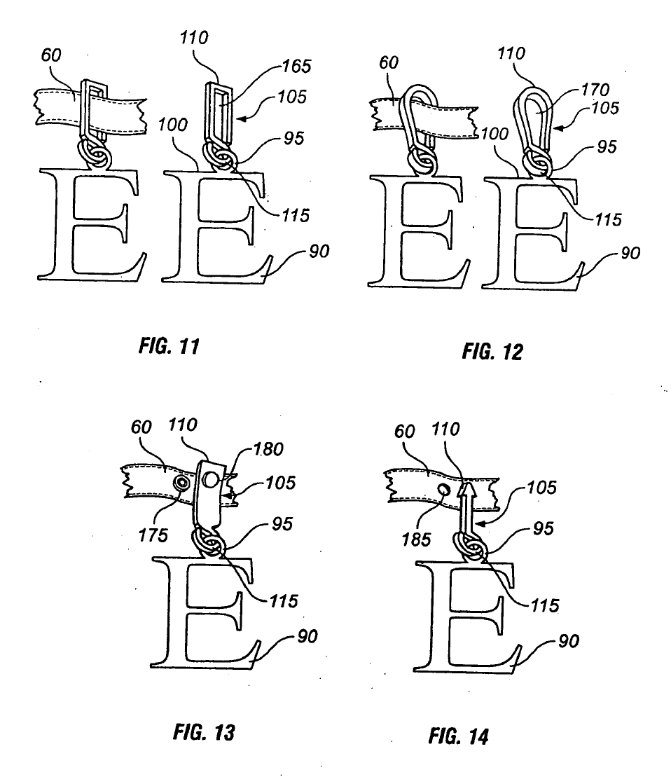

(11) In still a further variant, as illustrated in FIG. 11, the upper end 110 of the identifier hanger 105 has a rectangular opening 165. The rectangular opening 165 is sized and shaped to fit pivotally upon the display belt 60.

(12) In yet a further variant, as illustrated in FIG. 12, the upper end 110 of the identifier hanger 105 has a rounded opening 170. The rounded opening 170 is sized and shaped to fit pivotally upon the display belt 60.

(13) In another variant of the invention, as illustrated in FIG. 13, the display belt 60 has at least one snap portion 175 attached at the hanging loop 85 and the identifier hanger 105 has a mating snap portion 180 attached at the upper end 110 of the hanger 105.

(14) In still another variant, as illustrated in FIG. 14, the display belt 60 has at least one aperture 185. The aperture 185 penetrates the hanging loop 85 and the upper end 110 of the identifier hanger 105 is sized and shaped to engage the aperture 185.

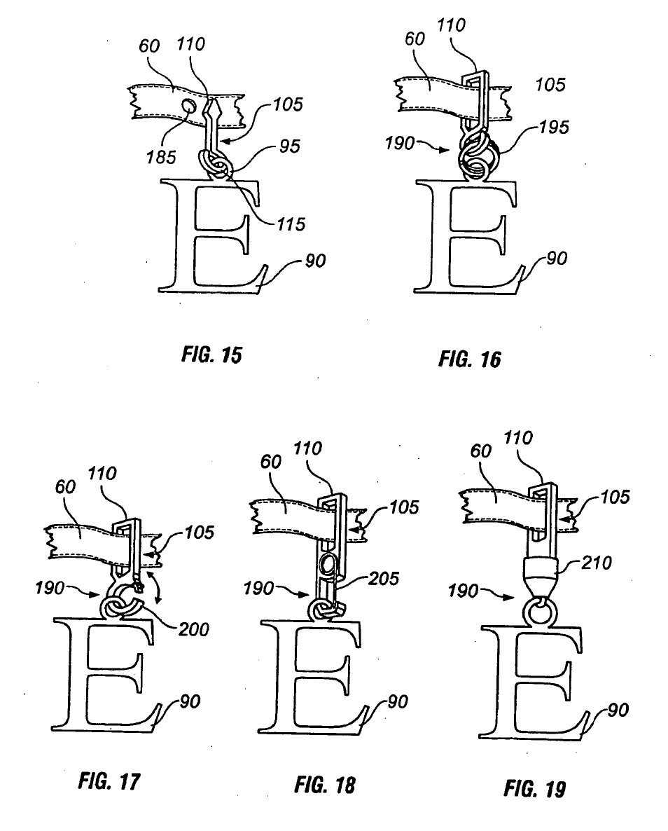

(15) In yet another variant, as illustrated in FIG. 15, the display belt 60 has at least one aperture 185. The aperture 185 penetrating the hanging loop 85 and the upper end 110 of the identifier hanger 105 is sized and shaped to removably engage the aperture 185.

(16) In a further variant, as illustrated in FIGS. 16-19, the lower end 115 of the identifier hanger 105 has an openable loop 190. The openable loop 190 permits removal and replacement of the decorative identifier 90.

(17) In still a further variant, as illustrated in FIG. 16, the openable loop 190 has a split ring 195.

(18) In yet a further variant, as illustrated in FIG. 17, the openable loop 190 has a spring-loaded movable portion 200.

(19) In still another variant, as illustrated in FIG. 18, the openable loop 190 has a coil spring clip 205.

(20) In a final variant of the invention, as illustrated in FIG. 19, the openable loop 190 has a snap swivel 210.

The system for attaching decorative identifiers to apparel and accessories 10 has been described with reference to particular embodiments. Other modifications and enhancements can be made without departing from the spirit and scope of the claims that follow.

1. A system for attaching decorative identifiers to apparel and accessories comprising:
a backing band attached to an outer surface of either of an item of apparel and an accessory item, wherein the backing band comprises at least two slits disposed substantially parallel to each other;
a display belt, wherein the display belt is interwoven through the backing band slits to provide at least two display belt hanging loops;
a hanger, wherein the hanger comprises an upper end and a lower end, wherein the hanger's upper end attaches to a display belt hanging loop, and wherein the hanger's lower end comprises a mechanism for removable attachment of a decorative identifier.

2. The system of claim 1 wherein said mechanism for removable attachment of a decorative identifier comprises an openable loop.

3. The system of claim 2 wherein said openable loop further comprises a split ring.

4. The system of claim 2 wherein said openable loop further comprises a spring-loaded movable portion.

5. The system of claim 2 wherein said openable loop further comprises a coil spring clip.

6. The system of claim 2 wherein said openable loop further comprises a snap swivel.

7. An item of apparel that comprises:
a backing band attached to an outer surface of the item of apparel, wherein the backing band comprises at least two slits disposed substantially parallel to each other;
a display belt interwoven through the backing band slits to provide at least two display belt hanging loops;
a hanger that comprises a first end and a second end, wherein the hanger's first end attaches to a said display belt hanging loop, and wherein the hanger's second end comprises a mechanism for removable attachment of a decorative identifier.

8. The item of apparel of claim 7 wherein said mechanism for removable attachment of a decorative identifier comprises an openable loop.

9. The item of apparel of claim 8 wherein said openable loop further comprises a split ring.

10. The item of apparel of claim 8 wherein said openable loop further comprises a spring-loaded movable portion.

11. The item of apparel of claim 8 wherein said openable loop further comprises a coil spring clip.

12. The item of apparel of claim 8 wherein said openable loop further comprises a snap swivel.

13. The item of apparel of claim 7 wherein the item of apparel is selected from the group consisting of footwear, headwear, belt, handbag and clothing.
